(19) United States
(12) Patent Application Publication
(10) Pub. No.: US 2016/0312701 A1
(43) Pub. Date: Oct. 27, 2016

(54) RADIANT SYNGAS COOLER

(71) Applicant: General Electric Company, Schenectady, NY (US)

(72) Inventors: Rajeshwar Sripada, Bangalore (IN); Asghar Ali Farooqui, Bangalore (IN); Pallab Karmakar, Bangalore (IN); Atul Kumar Vij, Bangalore (IN)

(21) Appl. No.: 14/693,513

(22) Filed: Apr. 22, 2015

(51) Int. Cl. F02C 7/143; F02C 6/04

(52) U.S. Cl. CPC F02C 7/143; F02C 6/04; F05D 2220/722; F05D 2260/221

(57) ABSTRACT

A radiant syngas cooler is provided and includes a vessel shell defining an interior region for cooling of syngas. The cooler also includes a tube cage comprising a plurality of tubes, each having a first end and a second end. The cooler further includes a plurality of platen tubes located radially inwardly from the tube cage. The cooler yet further includes a pipe fluidly coupling the second end of the plurality of tubes with an inlet of the plurality of platen tubes. The cooler also includes an outlet pipe fluidly coupling an outlet of the plurality of platen tubes with a steam usage structure. The cooler further includes an inlet pipe fluidly coupling the steam usage structure to the first end of the plurality of tubes of the tube cage.

### BACKGROUND

The subject matter disclosed herein relates to gasification systems and, more particularly, to a radiant syngas cooler for cooling syngas and generating steam.

A gasification process involves the partial combustion of feedstock (e.g., coal, gas, oil, biomass, etc.) inside of a gasification reactor to generate “producer gas,” which may also be referred to as syngas. This gas may then be used in a variety of applications. Prior to using the syngas in an application, the gas is commonly cooled in a syngas cooler. One type of syngas cooler is a radiant syngas cooler that employs radiant heat transfer between hot syngas and a cooling fluid flowing through tubes that are exposed to the syngas at an interior region of the syngas cooler.

A syngas cooler may include a plurality of platen tubes and a tube cage that defines a heat exchange surface area that facilitates transferring heat from the flow of syngas to cooling fluid channeled within each platen tube and tube cage. The plurality of platens in such syngas coolers are substantially circumscribed by the tube cage, which is further surrounded by a vessel shell. Known tube cages are designed to be gas-tight to retain syngas within the tube cage such that syngas contacts the tube cage rather than the cooler vessel shell.

At least some syngas coolers include a plurality of downcomers that extend generally axially within a space defined by the tube cage and the vessel shell, with the space often referred to as an annular gap. As a result, the diameter of the vessel shell of such coolers is sized to accommodate the plurality of downcomers in addition to heat transfer surfaces, including platen tubes and a tube cage. The vessel shell diameter is proportional to the cost of the syngas cooler and the heat exchange surface area of the tube wall. Additionally, the downcomers are used to route the cooling fluid to the platen tubes, but the downcomers are not located in the heat transfer exchange region of the syngas cooler, as noted above. Therefore, the cooling fluid therein is not heated until reaching the platen tubes and tube cage tubes. The cycle of operation of the overall system that the syngas cooler is used with typically includes utilizing steam generated in the syngas cooler for a beneficial application. By delaying heating of the cooling fluid until it reaches the platen tubes and tube cage tubes, steam is generated less efficiently during the heat transfer process.

### BRIEF DESCRIPTION

According to one embodiment, a radiant syngas cooler is provided and includes a vessel shell defining an interior region for cooling of syngas. The radiant syngas cooler also includes a tube cage comprising a plurality of tubes, each of the plurality of tubes having a first end and a second end and configured to exchange heat with syngas disposed in the interior region of the vessel shell. The radiant syngas cooler further includes a plurality of platen tubes located radially inwardly from the tube cage to exchange heat with syngas disposed in the interior region of the vessel shell. The radiant syngas cooler yet further includes a pipe fluidly coupling the second end of the plurality of tubes of the tube cage with an inlet of the plurality of platen tubes. The radiant syngas cooler also includes an outlet pipe fluidly coupling an outlet of the plurality of platen tubes with a steam usage structure to route steam generated to the steam usage structure. The radiant syngas cooler further includes an inlet pipe fluidly coupling the steam usage structure to the first end of the plurality of tubes of the tube cage to route water from the steam usage structure to the tube cage.

According to another embodiment, an integrated gasification combined cycle (IGCC) power generation system is provided. The IGCC system includes a gas turbine engine configured to utilize a syngas for combustion. The IGCC system also includes a gasifier configured to produce the syngas. The IGCC system further includes a steam drum configured to route steam to a steam turbine engine. The IGCC system yet further includes a radiant syngas cooler fluidly coupled to the gasifier to receive the syngas for cooling therein. The radiant syngas cooler includes a vessel shell defining an interior region. The radiant syngas cooler also includes a tube cage comprising a plurality of tubes, each of the plurality of tubes fluidly coupled to the steam drum to receive water at a first end of each of the plurality of tubes. The radiant syngas cooler further includes a plurality of platen tubes located radially inwardly from the tube cage and fluidly coupled to a second end of each of the plurality of tubes to receive heated water from the tube cage, the plurality of tubes configured to exchange heat with the syngas disposed in the interior region of the vessel shell for converting a portion of the heated water to a steam and water mixture. The radiant syngas cooler yet further includes an outlet pipe fluidly coupling an outlet of the plurality of platen tubes with the steam drum to route steam generated to the steam drum.

These and other advantages and features will become more apparent from the following description taken in conjunction with the drawings.

### BRIEF DESCRIPTION OF THE DRAWINGS

The subject matter described herein is particularly pointed out and distinctly claimed in the claims at the conclusion of the specification. The foregoing and other features, and advantages of the embodiments are apparent from the following detailed description taken in conjunction with the accompanying drawings in which:

FIG. 1 is a schematic illustration of a gasification system used in conjunction with a syngas application and a steam application; and

FIG. 2 is a perspective view illustrating a portion of a radiant syngas cooler.

The detailed description explains embodiments, together with advantages and features, by way of example with reference to the drawings.

### DETAILED DESCRIPTION

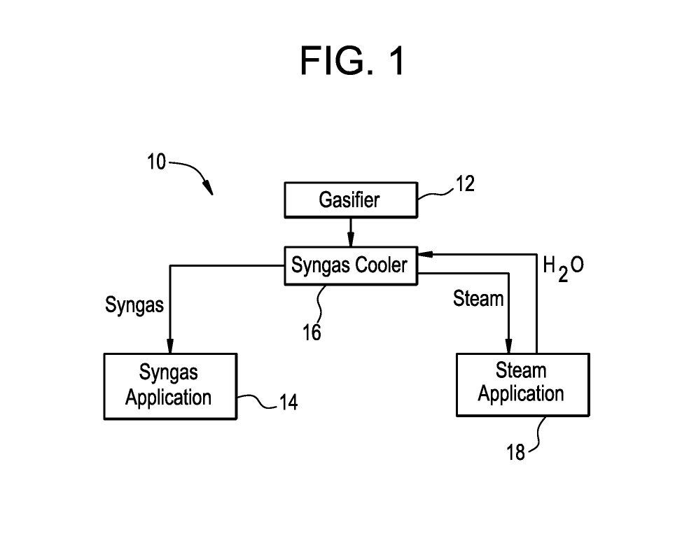

Referring to FIG. 1, a gasification system 10 is partially illustrated. A gasification system is configured to thermally convert feedstock into a more useful gaseous form of fuel (i.e., a fuel form that can be economically utilized with high energy recovery levels), referred to herein as “syngas.” The gasification system 10 includes a gasifier 12, within which the thermal conversion of feedstock is carried out. Although the gasification system may be used in conjunction with a number of contemplated systems, in one exemplary embodiment, the gasification system is used as part of an integrated gasification combined cycle (IGCC) power generation system. In such a system, the syngas produced in the gasifier 12 may be used as fuel for combustion operations of a gas turbine engine. The application in which the syngas is being employed is generically illustrated and referenced with numeral 14. It is to be understood that alternative systems may benefit from the embodiments disclosed herein. For example, a chemical application may be employed.

As shown and as will be appreciated from the description herein, the syngas generated by the gasifier 12 is routed to a syngas cooler 16, which facilitates cooling the syngas. The syngas cooler is a radiant syngas cooler. Steam generated during a cooling process of the syngas is distributed to a steam application 18. In the example of an IGCC power generation system, the steam application 18 is a steam drum that stores and routes steam to a steam turbine engine for additional power generation. A pump is included to supply feed water from the steam application 18 to the syngas cooler 16 to facilitate cooling of the syngas. The feed water is channeled through the syngas cooler 16, wherein the feed water is converted to steam, as described in more detail below. The steam is then returned to steam application 18 for use within the gasifier 12, the syngas cooler 16, and/or an additional component such as a steam turbine, as described above.

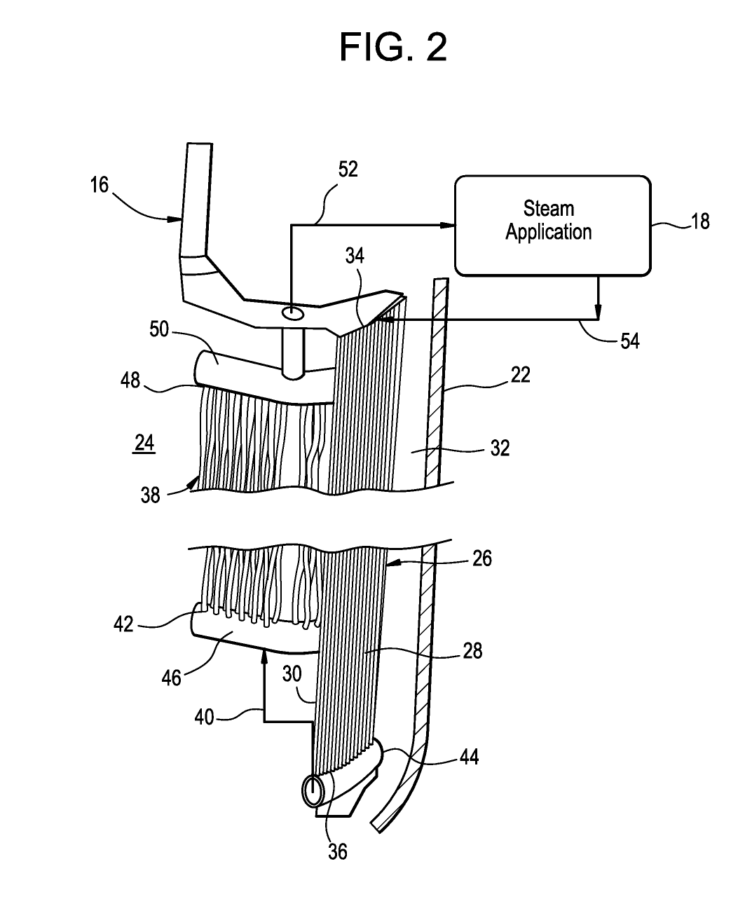

Referring now to FIG. 2, a portion of the syngas cooler 16 is schematically illustrated. In the illustrated embodiment, the syngas cooler 16 is a radiant syngas cooler. The syngas cooler 16 includes a vessel shell 22 that defines an interior region 24 within the syngas cooler 16. The syngas cooler 16 has a vessel radius that extends from a center axis (not labeled) to an inner surface of the vessel shell 22. The thickness and volume of the vessel shell 22 is proportional to the vessel radius of the vessel shell 22. Such increases result in an increase of the cost of the syngas cooler 16.

The syngas cooler 16 includes an annular membrane wall, referred to as a tube cage 26, that is disposed within the interior region 24 and that extends generally axially within the syngas cooler 16. The tube cage 26 is formed with a plurality of tubes, with each extending axially through a portion of the syngas cooler 16. The tube cage 26 includes a radially outer surface 28 and a radially inner surface 30. The radially inner surface 30 defines a heat exchange surface area that facilitates cooling of the syngas. A gap 32 is defined between the outer surface 28 of the tube cage 26 and the inner surface of the vessel shell 22, and may be referred to as an annulus. The gap 32 is pressurized to facilitate preventing the syngas from entering the annular gap 32. The gap 32 is typically sized to accommodate certain fluid routing components, such as a number of downcomers, but as will be appreciated from the description herein, by avoiding the need for downcomers in this gap 32, the size of the gap may be reduced significantly, thereby advantageously reducing the diameter of the vessel shell 22.

The tubes of the tube cage 26 each include an upstream end, also referred to herein as a first end 34, and a downstream end, also referred to herein as a second end 36. The first end 34 is located closer in proximity to an inlet end of the vessel shell 22, when compared to the proximity of the second end 36 to the inlet end of the vessel shell 22. The second end 36 is located closer in proximity to the outlet end of the vessel shell 22. The tube cage 26 is configured to route a cooling fluid therein from the first end 34 to the second end 36. In one embodiment, such as the embodiment used as part of an IGCC power generation system, the cooling fluid is water. As described above, the water exchanges heat with the hot syngas present in the syngas cooler 16. The heat exchange cools the syngas and heats the water. The water is pumped at a flow rate that ensures that the water does not boil in the tube cage 26. In one embodiment, the water is pumped at a rate that imparts sensible heating of the water to a saturation temperature by the time the water reaches the second end 36 of the tube cage 26.

Upon reaching the second end 36 of the tube cage, the water is routed to a plurality of platen tubes 38 that are fluidly coupled to the tube cage 26. The fluid coupling is made with a pipe 40 that extends between a location proximate the second end 36 of the tube cage 26 and an inlet end 42 of the plurality of platen tubes 38. One or both of the ends of the pipe 40 may be directly coupled to a manifold or header that facilitates routing of the flow. For example, the tube cage 26 includes a tube cage exhaust manifold 44 (or header) coupled to a location proximate the second end 36 of the tube cage. Similarly, a platen tube inlet manifold 46 is coupled to the inlet end 42 of the plurality of platen tubes 38. The precise location of expulsion of the water from the tube cage 26 may be at the second end 36 of the tube cage 26, such that the water is routed along an entire length thereof. Alternatively, the expulsion may occur just upstream of the second end 36. The location of expulsion of water may be selected to ensure that there is flow uniformity in the platen tubes.

The plurality of platen tubes 38 are located radially inwardly from the tube cage 26 within the interior region 24 of the vessel shell 22, such that the entirety of the exterior of the plurality of platen tubes 38 is exposed to the heated syngas present in the interior region 24 of the vessel shell 22. This provides a heat transfer surface that facilitates heat transfer between the syngas and the water flowing within the plurality of platen tubes 38 from the inlet end 42 to an outlet end 48. During the heat exchange, a portion of water is converted to steam prior to exiting the plurality of platen tubes 38. The quality and quantity of steam is driven by the end requirements and/or mechanical risk limitations of the system. Routing of the steam and water mixture from the plurality of platen tubes 38 may be facilitated by a platen tube exhaust manifold 50 coupled to the outlet end 48 of the tubes.

The steam generated within the plurality of platen tubes 38 is then routed along with water through an outlet pipe 52 fluidly coupling the plurality of platen tubes 38 with the steam usage structure 18 (e.g., steam drum). The steam routed to the steam usage structure 18 is separated and then used therein for any contemplated application that may benefit from steam, such as a steam turbine engine, as described above. The left over water with supplemental water added to a steam drum is routed back to the syngas cooler 16 in a loop system. Specifically, the water is routed from the steam usage structure 18 along an inlet pipe 54 fluidly coupling the steam usage structure 18 to the tube cage 26. More specifically, the water is routed to the first end 34 of the tube cage 26 for heating within the tube cage 26 and the plurality of platen tubes 38, as described in detail above.

In contrast to a syngas cooler 16 that routes water from a steam usage application to a number of downcomers located within the gap 32 at a position radially outward from the tube cage 26, all of the water sent to the syngas cooler 16 for heating (i.e., steam generation) therein is sent to the first end 34 of the tube cage 26. Several advantages result from the embodiments described herein. Introducing the water to the tube cage 26 reduces the gap 32 necessary between the tube cage 26 and the vessel shell 22, thereby reducing the overall cost of the syngas cooler 16. In addition to the size reduction, avoiding the need for downcomers reduces expenses associated with manufacturing of these components and/or maintaining them throughout their life period. Additionally, by routing the water through the tube cage 26, the water is exposed to a heat transfer surface provided by the tube cage 26 that advantageously heats the water before it is routed to the plurality of platen tubes 38. This pre-heating increases overall steam generation efficiency and provides an opportunity to reduce the length of the tube cage 26 and/or the plurality of platen tubes 38 and possibly the entire syngas cooler 16. A more efficient system also allows for a reduction in the required water flow rate, thereby decreasing size requirements associated with several system components, including the steam usage structure (e.g., steam drum) size and the manifold and/or header size, for example.

While the embodiments have been described in detail in connection with only a limited number of embodiments, it should be readily understood that the embodiments are not limited to such disclosed embodiments. Rather, the embodiments can be modified to incorporate any number of variations, alterations, substitutions or equivalent arrangements not heretofore described, but which are commensurate with the spirit and scope of the embodiments. Additionally, while various embodiments have been described, it is to be understood that aspects may include only some of the described embodiments. Accordingly, the embodiments are not to be seen as limited by the foregoing description, but are only limited by the scope of the appended claims.

What is claimed is:

1. A radiant syngas cooler comprising:
a vessel shell defining an interior region for cooling of syngas;
a tube cage comprising a plurality of tubes, each of the plurality of tubes having a first end and a second end and configured to exchange heat with syngas disposed in the interior region of the vessel shell;
a plurality of platen tubes located radially inwardly from the tube cage to exchange heat with syngas disposed in the interior region of the vessel shell;
a pipe fluidly coupling the second end of the plurality of tubes of the tube cage with an inlet of the plurality of platen tubes;
a steam usage structure;
an outlet pipe fluidly coupling an outlet of the plurality of platen tubes with a steam usage structure to route steam generated to the steam usage structure; and
an inlet pipe fluidly coupling the steam usage structure to the first end of the plurality of tubes of the tube cage to route water from the steam usage structure to the tube cage.

2. The radiant syngas cooler of claim 1, wherein all of the water provided to the radiant syngas cooler for steam generation is routed through the inlet pipe to the tube cage.

3. The radiant syngas cooler of claim 1, wherein the vessel shell comprises an inlet end and an outlet end, the first end of the plurality of tubes of the tube cage located proximate the inlet end of the vessel shell and the second end located proximate the outlet end of the vessel shell.

4. The radiant syngas cooler of claim 1, further comprising:
a tube cage exhaust manifold coupled to the second end of the plurality of tubes; and
a platen tube inlet manifold coupled to an inlet end of the plurality of platen tubes, wherein the pipe fluidly coupling the second end of the plurality of tubes of the tube cage with the inlet end of the plurality of platen tubes is directly coupled to the tube cage exhaust manifold and the platen tube inlet manifold.

5. The radiant syngas cooler of claim 1, further comprising a platen tube exhaust manifold coupled to an outlet end of the plurality of platen tubes.

6. The radiant syngas cooler of claim 1, wherein the water routed to the tube cage is heated to a saturation temperature within the plurality of tubes of the tube cage.

7. The radiant syngas cooler of claim 1, wherein the steam usage structure is a steam drum.

8. The radiant syngas cooler of claim 1, wherein the water provided to the plurality of tubes of the tube cage is routed along an entire length of the plurality of tubes.

9. The radiant syngas cooler of claim 1, wherein the radiant syngas cooler is disposed in an integrated gasification combined cycle system.

10. The radiant syngas cooler of claim 1, wherein the radiant syngas cooler is disposed in a chemical application.

11. An integrated gasification combined cycle (IGCC) power generation system comprising:
a gas turbine engine configured to utilize a syngas for combustion;
a gasifier configured to produce the syngas;
a steam drum configured to route steam to a steam turbine engine; and
a radiant syngas cooler fluidly coupled to the gasifier to receive the syngas for cooling therein, the radiant syngas cooler comprising:
a vessel shell defining an interior region;
a tube cage comprising a plurality of tubes, each of the plurality of tubes fluidly coupled to the steam drum to receive water at a first end of each of the plurality of tubes;
a plurality of platen tubes located radially inwardly from the tube cage and fluidly coupled to a second end of each of the plurality of tubes to receive heated water from the tube cage, the plurality of tubes configured to exchange heat with the syngas disposed in the interior region of the vessel shell for converting a portion of the heated water to steam to generate a steam and water mixture; and
an outlet pipe fluidly coupling an outlet of the plurality of platen tubes with the steam drum to route the steam and water mixture to the steam drum.

12. The IGCC power generation system of claim 11, wherein all of the water provided to the radiant syngas cooler for steam generation is routed through an inlet pipe to the tube cage.

13. The IGCC power generation system of claim 11, wherein the vessel shell comprises an inlet end and an outlet end, the first end of the plurality of tubes of the tube cage located proximate the inlet end of the vessel shell and the second end located proximate the outlet end of the vessel shell.

14. The IGCC power generation system of claim 11, further comprising:
a tube cage exhaust manifold coupled to the second end of the plurality of tubes; and
a platen tube inlet manifold coupled to an inlet end of the plurality of platen tubes, wherein a pipe is directly coupled to the tube cage exhaust manifold and the platen tube inlet manifold to fluidly couple the second end of the plurality of tubes of the tube cage with the inlet end of the plurality of platen tubes.

15. The IGCC power generation system of claim 11, further comprising a platen tube exhaust manifold coupled to an outlet end of the plurality of platen tubes.

16. The IGCC power generation system of claim 11, wherein the water routed to the tube cage is heated to a saturation temperature within the plurality of tubes of the tube cage.

17. The IGCC power generation system of claim 11, wherein the water provided to the plurality of tubes of the tube cage is routed along an entire length of the plurality of tubes.
